(19) United States
(12) Patent Application Publication
(10) Pub. No.: US 2018/0355845 A1
(43) Pub. Date: Dec. 13, 2018

(54) Low friction vertical axis-horizontal blade wind turbine with high efficiency

(71) Applicant: Okan Universitesi, Tuzla/Istanbul (TR)

(72) Inventor: yrd. Doc. Dr. Suleyman Biyikli, Tuzla/Istanbul (TR)

(21) Appl. No.: 16/064,543

(22) PCT Filed: Dec. 23, 2016
(86) PCT No.: PCT/TR2016/050523

§ 371 Date: Jun. 21, 2018

(30) Foreign Application Priority Data
Dec. 23, 2015 (TR) 2015/16677

(51) Int. Cl. F03D 3/06; F03D 3/00; F03D 80/70

(52) U.S. Cl. CPC F03D 3/061; F03D 3/005; F03D 80/70; F05B 2220/30; F05B 2240/50; F05B 2260/4031; F05B 2240/211; F05B 2220/706; F05B 2240/301

(57) ABSTRACT

This invention relates to a frictionless vertical axis-horizontal blade wind turbine with high efficiency, wherein a frictional force and lifting force created by horizontal blades (airfoil) are reduced by designing an axis attachment of the vertical blades as a horizontal blade (airfoil) to increase the efficiency and power of a wind turbine in a vertical-axis wind turbine model.

### TECHNICAL FIELD

This invention relates to a frictionless vertical axis-horizontal blade wind turbine with high efficiency, wherein a frictional force and lifting force created by horizontal blades (airfoil) are reduced by designing an axis attachment of the vertical blades as a horizontal blade (airfoil) to increase the efficiency and power of a wind turbine in a vertical-axis wind turbine model.

### PRIOR ART

Wind turbines which are traditionally used in the state of the art are evaluated in three main groups:

1. Horizontal-axis wind turbines

Vertical-axis wind turbines

Inclined-axis wind turbines

Technical features relating to these turbines are provided below.

1. Horizontal-axis wind turbines: In such turbines, the axis of rotation is parallel to the wind direction. Their blades are at a right angle to the wind direction. Commercial turbines generally have horizontal axes. Rotor is placed on a rotary table such that it is exposed to the wind in the best way.

Most of the horizontal-axis wind turbines are designed such that they are exposed to the wind from the front side. The wind turbines which are exposed to the wind from the rear side are less common. The advantage of the wind turbines which are exposed to the wind from the front side is that they are not affected by the wind shade created by the tower. The disadvantage is that there is a steering system to allow the turbine to face against the wind continuously.

An exemplary horizontal-axis wind turbine is propeller type wind turbine. The blades of such turbines may be integral, or they may be consisted of two or more pieces. The most common type currently used is the ones having three blades. These turbines are used to produce electrical energy. In the past, multi-blade turbines were used to mill grains, pump water and cut trees.

2. Vertical-axis wind turbines: The turbine shaft is arranged vertically and is perpendicular to the direction from which the wind comes. There are various types such as Savonius, Darrieus, etc. They are mostly for the experimental purposes. Their commercial use is rare.

In Darrieus vertical-axis wind turbines, there are two blades arranged vertically. The blades are positioned such that the turbine shaft forms almost an ellipse with a long axis. A rotation movement arises due to the tractive force difference between the concave and convex surfaces of the blades. In Darrieus wind turbines, a maximum torque per revolution is obtained twice due to its nature. Given that the wind blows from one side, the power from the turbine forms a sinusoid curve.

Savonius wind turbines are a combination of two or three scoop-like sections. The most common type has two scoops and looks like an “S” shape. In Savonius wind turbine, the fluid follows a turbulent path on the concave blade and rotary flows are created herein. These rotary flows reduce the performance of Savonius wind turbine; accordingly they are rarely used in power generation. They are mostly used for pumping purposes, or as an anemometer used for wind measurements.

3. Inclined-axis wind turbines are the wind turbines, the axis of rotation of which makes an angle with the vertical in the wind direction. There is a certain angle between the blades and the axis of rotation of such turbines.

Furthermore it is seen in the patent application WO2011/033348 in the state of the art that “the connection arms of the vertical-axis wind turbine are designed as an airfoil.” However, there is no angle of attack in the connection arms, which reduces friction by using the lifting force of the wind. Likewise, the wind drag force is not used by designing the vertical blades as a bowl.

In the patent application WO2008141763 in the state of the art it is stated that “the supporting arms for the wind turbines with a vertical axis of rotation are designed by an airfoil modelling.” In this application the angle of attack of the horizontal arms or bowl-shaped vertical blades are not according to the invention.

The patent application US2015233344 which is another document in the state of the art discloses that the angle of attack for the blades is in the range of 0 and 21 degrees. However, this document differs from the frictionless vertical axis-horizontal blade wind turbine with high efficiency according to the invention as it can be applied to a horizontal-axis wind turbine system and the selection of the angle of attack does not result in a reduction of the blade weights by using the lifting force.

### SUMMARY OF INVENTION

In the vertical-axis wind turbines, the blades (airfoil) are mounted in parallel to the vertical axis. The vertical blades (airfoil) are connected to the turbine body via horizontal connecting members. The existing vertical-axis wind turbines have an efficiency that is about 25% lower as compared to the horizontal-axis turbines.

The frictionless vertical axis-horizontal blade wind turbine with high efficiency according to the invention operates at lower wind speeds and at higher efficiencies by designing the horizontal connecting members for the blades of the vertical-axis wind turbines as a blade (airfoil).

### DETAILED DESCRIPTION OF THE INVENTION

The frictionless vertical axis-horizontal blade wind turbine with high efficiency provided in order to achieve the object of the invention is shown in the accompanying figures, in which:

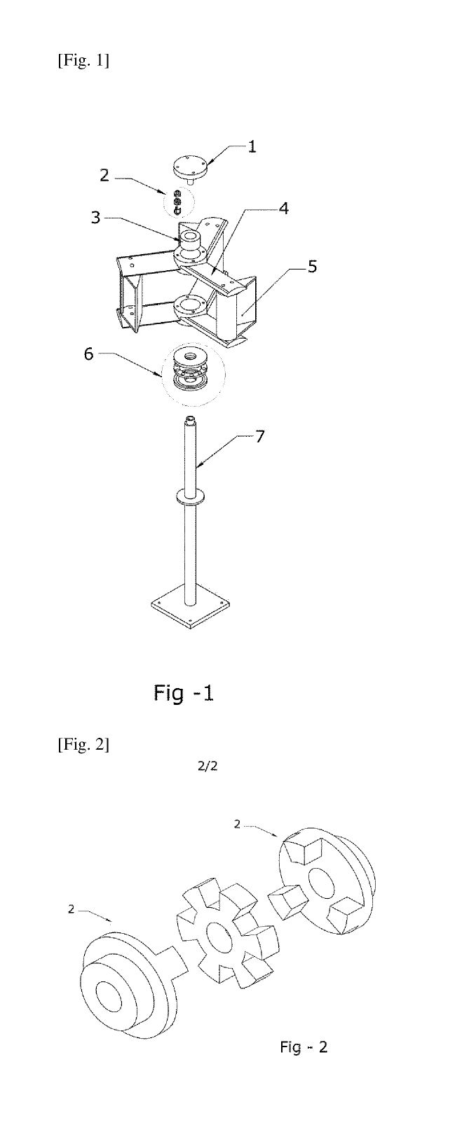

FIG. 1 is an exploded view of the parts of the frictionless vertical axis-horizontal blade wind turbine with high efficiency in accordance with the invention.

FIG. 2 is an exploded view of the flexible clutch of the frictionless vertical axis-horizontal blade wind turbine with high efficiency in accordance with the invention.

The parts which form the frictionless vertical axis-horizontal blade wind turbine with high efficiency according to the invention are numbered in the accompanying figures as follows.

1. Hub Generator

2. Flexible Clutch

3. Bushing

4. Horizontal Blade (airfoil)

5. Vertical Blade

6. Roller Bearing

7. Vertical Axis/Post

The frictionless vertical axis-horizontal blade wind turbine with high efficiency according to the invention is formed integrally by Hub Generator (1), Flexible Clutch (2), Bushing (3), Horizontal Blade (airfoil) (4), Vertical Blade (5), Roller Bearing (6) and Vertical Axis/Post (7) members.

The hub generator (1) provides conversion of the mechanical energy from the wind to the electrical energy. The hub generator (1) is connected to the horizontal blades (airfoil) (4) via the flexible clutch (2). There are at least two flexible clutches (2) in the system. The flexible clutch (2) allows the axial movements which would result from the lifting force created by the horizontal blades (airfoil) (4) in the wind turbine, to be absorbed.

The blade system is consisted of horizontal blades (airfoil) and vertical blades (5). Both the lifting force as a vertical component and the drag force as a horizontal component, of the wind may be used effectively due to the two types of such blades.

The vertical blades (5) are designed in the form of a bowl. The drag force is used at a low wind speed via the bowl-shaped vertical blades (5). The drag force increases the rotation speed and torque about the vertical axis/post (7).

The horizontal blades (airfoil) (4) are used to connect the bowl-shaped vertical blades (5) to the vertical axis of rotation of the turbine. The angle of attack of the horizontal blades (airfoil) (4) is in the range of 0 and 10°. A lifting force is formed to reduce the selected angle of attack and the friction resulting from the weight of the blade system. The power and the efficiency of the turbine are increased owing to the friction reduction.

The blade system consisting of the horizontal blades (airfoil) (4) and the vertical blades (5) is placed on a fixed axial roller bearing (6).

The lifting force created on the vertical axis reduces the friction formed in the roller bearing (6) due to the angle of attack of the horizontal blades (airfoil) (4).

The axial movement of the horizontal blades (airfoil) (4) traveling in the upward direction is absorbed by the flexible clutch (2). The flexible clutches transfers the rotation torque created by the turbine blades to the rotor of the hub generator, thereby the power is generated. Stator of the hub generator is fixed via a connection to the vertical axis/post (7).

The foregoing invention essentially relates to a frictionless vertical axis-horizontal blade wind turbine with high efficiency which makes the horizontal blades (airfoil) (4) of the vertical-axis wind turbines highly efficient by reducing the friction.

In this basic concept the frictionless vertical axis-horizontal blade wind turbine with high efficiency according to the invention is essentially as defined in the claims.

1. A frictionless vertical axis-horizontal blade wind turbine with high efficiency according to the invention, characterized by comprising Hub Generator (1), Flexible Clutch (2), Bushing (3), Horizontal Blade (airfoil) (4), Vertical Blade (5), Roller Bearing (6) and Vertical Axis/Post (7) members to ensure high efficiency at low wind speeds.

2. The frictionless vertical axis-horizontal blade wind turbine with high efficiency as claimed in claim 1, characterized by comprising horizontal blades (airfoil) (4) which reduce the friction by using the lifting force being a vertical component of the wind and which have an angle of attack in the range of 0-10°.

3. The frictionless vertical axis-horizontal blade wind turbine with high efficiency as claimed in claim 1, characterized by comprising bowl-shaped vertical blades (5) which provide high efficiency at low wind speeds by using the horizontal drag force of the wind.

4. The frictionless vertical axis-horizontal blade wind turbine with high efficiency as claimed in claim 1, characterized by comprising at least two flexible clutches (2) to absorb the axial movements which may be resulted from the lifting force created by the horizontal blades (airfoil) (4).
